(19) United States
(12) Patent Application Publication
(10) Pub. No.: US 2004/0011388 A1
(43) Pub. Date: Jan. 22, 2004

(54) Cleaning apparatus for cleaning semiconductor substrate, and method of manufacturing semiconductor device

(75) Inventors: Hiroshi Tanaka, Tokyo (JP); Naoki Yokoi, Tokyo (JP); Kazutoshi Anabuki, Tokyo (JP); Masahiko Higashi, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/331,551

(22) Filed: Dec. 31, 2002

(30) Foreign Application Priority Data
Jul. 18, 2002 (JP) 2002-209344

(51) Int. Cl. B08B 3/00

(52) U.S. Cl. 134/105; 134/157

(57) ABSTRACT

A side edge of a wafer is retained by a plurality of chuck pins. A heating-and-cooling section is arranged such that a clearance is defined between a surface of the heating-and-cooling section and a surface of the wafer. The heating-and-cooling section is for heating or cooling the surface thereof. The clearance is filled with liquid by means of a liquid filling section. The surface of the wafer is heated or cooled by way of the thus-filled liquid.

### BACKGROUND OF THE INVENTION

1. Field of the Invention

The invention relates to a technique for manufacturing a semiconductor device, and more particularly, to an apparatus for cleaning a semiconductor substrate.

2. Description of the Background Art

By reference to FIG. 7, a conventional cleaning apparatus will be described.

FIG. 7 is a cross-sectional view for describing a conventional cleaning apparatus.

In FIG. 7, reference numeral 1 designates a wafer which is to serve as a semiconductor substrate; 51 designates a chuck pin provided in a wafer retaining section 50; 52 designates a liquid supply section; 53 designates a liquid supplied from the liquid supply section 52; and 54 designates gas supplied by way of a through hole 50a formed in the center of the wafer retaining section 50.

Operation of the cleaning apparatus will now be described.

First, the wafer 1 is retained by the chuck pin 51 of the wafer retaining section 50.

Next, the wafer retaining section 50 is rotated, thereby spinning the wafer 1 at a predetermined speed.

While the wafer 1 is being rotated, gas 54 is supplied to one surface 1a of the wafer 1 by way of the through hole 50a formed in the center of the wafer retaining section 50, and the liquid 53 is supplied to another surface 1b of the wafer 1 by way of the liquid supply section 52. As a result, the wafer 1 is cleaned. Here, the liquid 53 is a generic name encompassing all chemicals, all solvents, and pure water which are used for cleaning the wafer 1. In addition, the gas 54 designates an inert gas such as nitrogen gas or dry air.

In the cleaning apparatus, when the temperature of the surface 1b to be brought into contact with the liquid 53 (hereinafter called a “liquid-contact surface temperature”) is maintained not at room temperature (e.g., 25° C. or thereabouts) but at a high temperature; e.g., 80° C. or thereabouts, there has been commonly employed a method of continuously supplying the liquid 53 that has been heated to 80° C. or more in advance to the surface 1b of the wafer 1.

At this time, in order to suppress the quantity of liquid 53 consumed and enhance heat efficiency, a circulation circuit (not shown) is constituted, wherein the liquid 53 used for cleaning is recovered and the thus-recovered liquid is heated again and used repeatedly.

Incidentally, there is also conceivable a method of heating the wafer 1 by use of high-temperature gas. However, the heat conductivity of the gas is low, and hot gas far exceeding 80° C. must be continuously supplied in high quantity. Moreover, the gas takes in a fluid volatile component, and hence the gas cannot be recycled by way of the circulation circuit. For this reason, a method for heating the wafer 1 with gas has not been employed.

As mentioned above, when the conventional cleaning apparatus performs a cleaning operation at a temperature different from room temperature (e.g., at a high temperature), a circulation circuit is constituted, and liquid is recycled while being circulated.

However, the cleaning effect of much of liquid used for cleaning is sensitively changed by variations in composition resulting from volatilization or decomposition. A nominal difference arises between liquids in terms of the accumulated number of times liquid is used or the accumulated period of time liquid is used, thereby resulting in occurrence of a cleaning failure.

Avoiding occurrence of a cleaning failure requires a laborious operation for setting, for each cleaning process, a life with allowance in consideration of limitations to use of liquid.

Further, the conventional cleaning apparatus requires a large-scale circulation circuit which uses a recovery tank, a pump, a heater (thermal equipment), and a filter. Since the circulation circuit is large, limitations are imposed on the number of circulation circuits which can be installed in one cleaning apparatus. Moreover, one type of liquid and one temperature condition can be selected for one circulation circuit. Hence, freedom of choice is severely limited in connection with the type of liquid and a predetermined temperature, thus rendering the range of application of a cleaning apparatus narrow.

### SUMMARY OF THE INVENTION

The present invention has been conceived to solve the previously-mentioned problems and a general object of the present invention is to provide a novel and useful cleaning apparatus, and is to provide a novel and useful method of manufacturing a semiconductor device.

A more specific object of the present invention is to maintain high cleaning performance and render the same stable without involvement of an operation for setting the life of liquid, and is to provide cleaning apparatus which affords a high degree of freedom in connection with the type of liquid and temperature settings and a wide range of application.

The above object of the present invention is attained by a following cleaning apparatus and method of manufacturing a semiconductor device.

According to one aspect of the present invention, the cleaning apparatus comprises a substrate retaining section for retaining a side edge of a substrate. A first heating-and-cooling section is for heating or cooling a surface thereof and arranged such that a predetermined first clearance is provided between the surface of the first heating-and-cooling section and one surface of the substrate. A first cleaning liquid filling section is for filling the first clearance with first cleaning liquid.

According to another aspect of the present invention, in the method of manufacturing a semiconductor device, a substrate is cleaned through use of the cleaning apparatus according to one aspect of the present invention.

Other objects and further features of the present invention will be apparent from the following detailed description when read in conjunction with the accompanying drawings.

### BRIEF DESCRIPTION OF THE DRAWINGS

FIG. 1 is a cross-sectional view for describing a cleaning apparatus according to a first embodiment of the present invention;

FIG. 2 is a cross-sectional view for describing a cleaning apparatus according to a second embodiment of the present invention;

FIG. 3 is a cross-sectional view for describing a cleaning apparatus according to a third embodiment of the present invention;

FIG. 4 is a view showing a first example of a pattern provided in a plane of a heating-and-cooling section;

FIG. 5 is a view showing a second example of a pattern provided in a plane of the heating-and-cooling section;

FIG. 6 is a cross-sectional view for describing a cleaning apparatus according to a fourth embodiment of the present invention; and

FIG. 7 is a cross-sectional view for describing a conventional cleaning apparatus.

### DETAILED DESCRIPTION OF THE PREFERRED EMBODIMENTS

In the following, principles and embodiments of the present invention will be described with reference to the accompanying drawings. The members and steps that are common to some of the drawings are given the same reference numerals and redundant descriptions therefore may be omitted.

First Embodiment

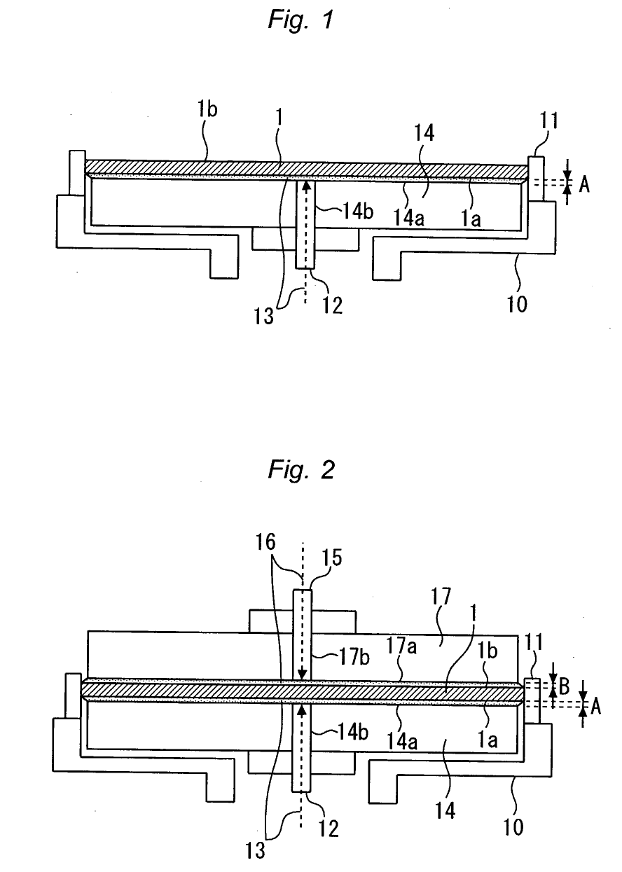

FIG. 1 is a cross-sectional view for describing a cleaning apparatus according to a first embodiment of the present invention. FIG. 4 is a view showing a first example of a pattern provided in a plane of a heating-and-cooling section. FIG. 5 is a view showing a second example of a pattern provided in a plane of the heating-and-cooling section.

As shown in FIG. 1, reference numeral 1 designates a wafer (semiconductor substrate); 10 designates a wafer retaining section; 11 designates a chuck pin; 12 designates a liquid filling section; 13 designates liquid; and 14 designates a heating-and-cooling section.

Here, the chuck pin 11 is provided at an upper edge of the wafer retaining section 10 and is formed from material having low heat conductivity. The chuck pin 11 does not affect the temperature distribution of the wafer 1; namely, the chuck pin 11 does not have any heat capacity. The wafer 1 does not contact a member having heat capacity. The chuck pin 11 retains the wafer 1 from the direction of a side edge.

The wafer retaining section 10 has a mechanism for effecting rotation around the center of the wafer 1. By means of such a rotating action, the wafer 1 is rotated at a given speed. Here, the wafer retaining section 10 is separated from the liquid filling section 12 and the heating-and-cooling section 14. For this reason, the wafer 1 is rotated relative to the heating-and-cooling section 14.

The liquid filling section 12 is for filling, with the liquid 13, a clearance A (which will be described later) existing between a plane 14a of the heating-and-cooling section 14 and one surface 1a of the wafer 1. Here, the liquid 13 is a generic name encompassing all chemicals, solvents, and pure wafer used for cleaning the wafer 1 (the same also applies to liquid 16, 19 employed in second and third embodiments, which will be described later).

The heating-and-cooling section 14 has at least one plane 14a, and has a mechanism of effecting heating and cooling operations of the plane 14a. The heating-and-cooling section 14 is arranged such that the plane 14a opposes the surface 1a of the wafer 1 and such that a given clearance A is defined between the plane 14a and the surface 1a. The length of the clearance A is set so as to fall within a range of 0.2 mm to 3 mm. A through-hole 14b is provided in the center of the heating-and-cooling section 14 so as to penetrate therethrough in a vertical direction. The liquid filling section 12 is provided in the through-hole 14b. The heating-and-cooling section 14 is disposed on the side of the wafer 1 facing the wafer retaining section 10. In other words, the liquid 13 whose temperature is controlled is supplied to the surface 1a of the wafer 1 facing the wafer retaining section 10.

As shown in FIG. 4, a pattern 14c consisting of a plurality of indentations (or grooves) radially extending from the center to an outer periphery is formed in the plane 14a of the heating-and-cooling section 14. The pattern 14c enables an improvement in temperature uniformity within a concentric circle.

As shown in FIG. 5, a pattern 14d consisting of dot-shaped indentations may be employed in place of the pattern 14c. The pattern 14d promotes agitation of liquid, thereby improving temperature uniformity.

The operation of the cleaning apparatus; that is, a method of cleaning a wafer, will now be described.

First, the wafer 1 is retained by the chuck pin 11 provided on the wafer retaining section 10.

Next, the wafer 1 is rotated at a predetermined speed by means of rotating the wafer retaining section 10.

The liquid 13 is supplied from the liquid filling section 12, thereby filling the clearance A defined between the plane 14a of the heating-and-cooling section 14 and the surface 1a of the wafer 1 with a required quantity of liquid 13. Here, the require quantity signifies an appropriate quantity of liquid which fills the clearance A but does not overflow from the clearance A.

Next, the temperature of the surface 1a that remains in contact with the liquid 13 by way of the liquid 13 filled in the clearance A (hereinafter the temperature will be called a “liquid-contact surface temperature”) is heated (or cooled) to a predetermined temperature by means of heating (or cooling) operation of the heating-and-cooling section 14. Here, as mentioned previously, the length of the clearance A defined between the heating-and-cooling section 14 and the wafer 1 is minute. The liquid 13 that is filled-in the clearance A has a high heat conductivity, and hence the liquid 13 is instantaneously heated (or cooled), whereby the liquid-contact surface temperature immediately reaches a predetermined temperature (e.g., 80° C.).

The wafer 1 (surface 1a) is cleaned at a predetermined liquid-contact surface temperature.

After completion of cleaning of the wafer 1, the liquid 13 is disposed of. In other words, the liquid 13 is for single use, and the clearance A is filled with new liquid 13 at each cleaning operation. In the first embodiment, this can be achieved by filling the clearance A with only a nominal quantity of liquid 13. The quantity of liquid used is smaller than that used in a conventional case where a large quantity of liquid 53 is continuously supplied.

As mentioned above, in the first embodiment, the wafer 1 and the heating-and-cooling section 14 are arranged so as to oppose each other such that the clearance A is defined between the surface 1a of the wafer 1 and the plane 14a of the heating-and-cooling section 14. The clearance A is filled with the liquid 13 through use of the liquid filling section 12. The thus-filled liquid 13 is heated or cooled by the heating-and-cooling section 14, whereby the wafer 1 is cleaned at a predetermined liquid-contact surface temperature. Further, the liquid 13 having been used for cleaning is disposed of.

According to the first embodiment, the clearance A is filled with new liquid 13 at each cleaning operation, and the liquid is heated or cooled at the time of cleaning operation by means of the heating-and-cooling section 14. As a result, stable cleaning operation can be performed at all times. In short, high cleaning performance can be maintained and made stable without involvement of a laborious operation for setting the life of liquid with allowance for each of cleaning operations in consideration of use limit of liquid.

As a result of the liquid 13 being for single use, there is obviated a necessity for constituting a large-scale circulation circuit (not shown) using a recovery tank, a pump, a heater (heating-and-cooling equipment), and a filter. A new liquid supply circuit (not shown) is much smaller in size than the circulation circuit, and hence a plurality of new liquid supply circuits can be disposed in the space where the conventional circulation circuit was disposed. In other words, desired liquid can be selected from a plurality of types of new liquid (i.e., new fluid). Moreover, the heating-and-cooling section 14 enables a heating or cooling operation to a desired temperature. Accordingly, the degree of freedom pertaining to the type of liquid and temperature settings is increased, and a cleaning apparatus having a wide range of application can be realized.

The chuck pin 11 that comes into contact with the wafer 1 has a low thermal conductivity, and a small contact area exists between the wafer 1 and the chuck pin 11. A member which would deteriorate the temperature distribution of the wafer 1; that is, a member having temperature capacity, does not contact the wafer 1. Accordingly, the liquid 13 filled in the clearance A can be momentarily heated or cooled by the heating-and-cooling section 14, whereby a desired liquid-contact surface temperature can be achieved within a short period of time. Accordingly, the cleaning process can be made stable, thereby improving a throughput.

Second Embodiment

FIG. 2 is a cross-sectional view for describing a cleaning apparatus according to a second embodiment of the present invention.

In FIG. 2, reference numeral 1 designates a wafer; 10 designates a wafer retaining mechanism; 11 designates a chuck pin; 12 designates a first liquid filling section; 13 designates first liquid; 14 designates a first heating-and-cooling section; 15 designates a second liquid filling section; 16 designates second liquid; and 17 designates a second heating-and-cooling section.

The cleaning apparatus of the first embodiment is equipped with one liquid filling section 12 and one heating-and-cooling section 14. In contrast, the cleaning apparatus of the second embodiment shown in FIG. 2 has two liquid filling sections 12, 15 and two heating-and-cooling sections 14, 17.

The elements described in connection with the first embodiment are assigned the same reference numerals, and their repeated explanations are omitted.

In FIG. 2, the second liquid filling section 15 is for filling, with second liquid 16 differing in type from the first liquid 13, a clearance B (which will be described later) existing between a plane 17b of the second heating-and-cooling section 17 and another surface 1b of the wafer 1.

The second heating-and-cooling section 17 has at least one plane 17a, and has a mechanism of effecting heating and cooling operations of the plane 17a. The second heating-and-cooling section 17 is arranged such that the plane 17a opposes the surface 1b of the wafer 1 and such that a predetermined clearance B is defined between the plane 17a and the surface 1b of the wafer 1. As in the case of the clearance A, the length of the clearance B ranges from 0.2 mm to 3 mm. Further, a through-hole 17b is formed in the center of the second heating-and-cooling section 17 so as to penetrate therethrough in a vertical direction. The second liquid filling section 15 is provided in the through-hole 17b. The previously-described patterns 14c and 14d (see FIGS. 4 and 5) are formed also in the plane 17a of the second heating-and-cooling section 17.

Operation of the cleaning apparatus will now be described.

First, as in the case of the first embodiment, the wafer 1 is retained by the chuck pin 11 and rotated at a given speed.

Next, the first liquid 13 is supplied from the first liquid filling section 12, thereby filling the clearance A defined between the plane 14a of the first heating-and-cooling section 14 and the plane 1a of the wafer 1 with a required quantity of the first liquid 13.

Concurrently, the second liquid 16 is supplied from the second liquid filling section 15, thereby filling the clearance B defined between the plane 17a of the second heating-and-cooling section 17 and the other surface 1b of the wafer 1 with a required quantity of the second liquid 16.

Next, the temperature of the surface 1a of the wafer 1 remaining in contact with the first liquid 13 is heated (or cooled) to a predetermined temperature (i.e., the first liquid-contact surface temperature) via the first liquid 13 provided in the clearance A, by means of heating (or cooling) operation of the first heating-and-cooling section 14. The surface 1a of the wafer 1 is cleaned at the first liquid-contact surface temperature.

Simultaneously, the temperature of the surface 1b of the wafer 1 remaining in contact with the second liquid 16 is heated (or cooled) to a predetermined temperature (i.e., the second liquid-contact surface temperature) via the second liquid 16 provided in the clearance B, by means of heating (or cooling) operation of the second heating-and-cooling section 17. The surface 1b of the wafer 1 is cleaned at the second liquid-contact surface temperature. At this time, the second liquid-contact surface temperature immediately reaches a preset temperature.

After cleaning the wafer 1 (i.e., the surfaces 1a and 1b), the first liquid 13 and the second liquid 16 are disposed of.

As mentioned above, in the second embodiment, the cleaning apparatus of the first embodiment further has the liquid filling section 15 and the heating-and-cooling section 17 provided above the surface 1b of the wafer 1. The first liquid 13 and the second liquid 16 are completely separated from each other by means of the wafer 1 and are not mixed.

As a result, in addition to yielding the advantage yielded in the first embodiment, the second embodiment enables simultaneous cleaning of the surfaces 1a and 1b of the wafer 1 with use of different types of liquid under independent temperature conditions. Consequently, cleaning capability can be enhanced considerably.

In the second embodiment, the first liquid 13 differs in type from the second liquid 17. However, liquid of the same type may be employed. The first liquid-contact surface temperature and the second liquid-contact surface temperature can be made identical with each other.

In the second embodiment, the clearances A and B are imparted with identical length. However, the clearances may differ in length from each other.

Third Embodiment

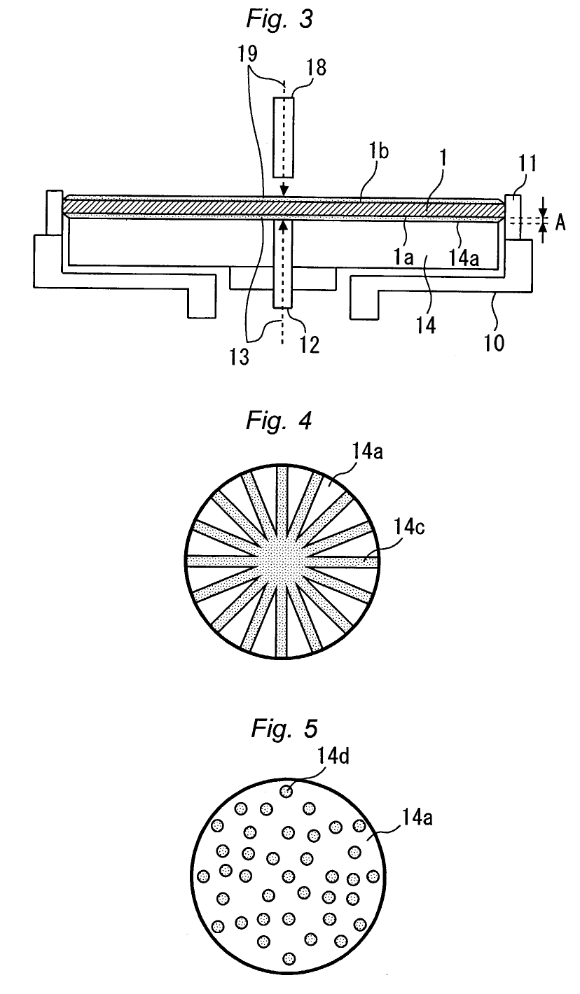

FIG. 3 is a cross-sectional view for describing a cleaning apparatus according to a third embodiment of the present invention.

In the second embodiment, the liquid filling section and the heating-and-cooling section are provided in groups of two for simultaneously subjecting the surfaces 1a and 1b of the wafer 1 to different cleaning operations under independent temperature conditions and through use of separated liquids. The third embodiment is directed toward a cleaning apparatus which is based on the cleaning apparatus of the second embodiment shown in FIG. 2. The third embodiment is made simpler in structure than the same so that different cleaning operations can be carried out simultaneously through use of separated liquids, by means of utilizing a high conductivity level of the wafer 1 and limiting cleaning operations for the surfaces 1a and 1b which are close to each other in terms of temperature conditions. More specifically, the cleaning apparatus of the third embodiment shown in FIG. 3 differs from that described in connection with the second embodiment in that the second liquid filling section 15 and the second heating-and-cooling section 17 are omitted and that a liquid supply section 18 for supplying second liquid 19 is provided.

Operation of the cleaning apparatus of the third embodiment will now be described.

The cleaning apparatus operates in the same manner as that descried in connection with the second embodiment up to the step of filling the clearance A with the first liquid 13.

As shown in FIG. 3, the second liquid 19 is uniformly supplied to the surface 1b of the wafer 1 from the liquid supply section 18.

As in the second embodiment, the surface 1a of the wafer 1 is heated to the first liquid-contact surface temperature by means of heating (or cooling) operation of the first heating-and-cooling section 14 by way of the liquid 13 provided in the clearance A. Since the wafer 1 has a high heat conductivity level, the second liquid-contact surface temperature of the other surface 1b of the wafer 1 remaining in contact with the liquid 19 immediately reaches a temperature close to the first liquid-contact surface temperature.

After cleaning of the wafer 1 (i.e., the surfaces 1a and 1b), the first liquid 13 and the second liquid 19 are disposed of.

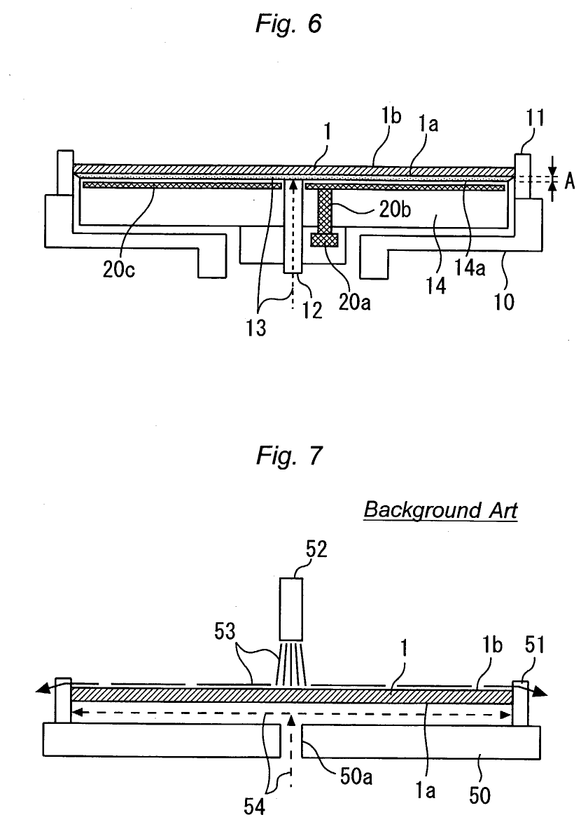

As has been described, in addition to yielding the advantage yielded in the first embodiment, the third embodiment yields the same advantage as that yielded in the second embodiment, by employment of a structure simpler than that employed in the second embodiment when a small difference exists between the liquid-contact surface temperature of the wafer surface 1a and that of the wafer surface 1b. Fourth Embodiment FIG. 6 is a cross-sectional view for describing a cleaning apparatus according to a fourth embodiment of the present invention.

In the fourth embodiment, the cleaning apparatus of the first embodiment is provided with a vibrating mechanism for vibrating the plane 14a of the heating-and-cooling section 14.

In FIG. 6, reference numeral 20a designates a vibrator which vibrates upon receipt of a predetermined voltage applied from the outside; 20b designates vibration transmission liquid for transmitting vibration of the vibrator 20a to a vibration plate (which will be described later); and 20c designates a vibration plate which vibrates the plane 14a of the heating-and-cooling section 14 by means of the vibration transmitted from the vibrator 20a by way of the vibration transmission liquid 20b. As shown in FIG. 6, a vibration mechanism constituted of the vibrator 20a, the vibration transmission fluid 20b, and the vibration plate 20c is provided within the heating-and-cooling section 14.

While the liquid 13 provided in the clearance A is being stirred on the surface 1a of the wafer 1 by rotating the wafer 1 relative to the heating-and-cooling section 14, a predetermined voltage is applied to the vibrator 20a from the outside. As a result of application of the voltage, the vibrator 20a generates vibration, and the vibration is transmitted to the vibration plate 20c by way of the vibration transmission liquid 20b. The vibrator 20a vibrates the plane 14a of the heating-and-cooling section 14.

In addition to yielding the advantage yielded by the first embodiment, the fourth embodiment set forth yields an advantage of the ability to promote agitation of the liquid 13 on the surface 1a of the wafer 1 and improve temperature uniformity of the liquid 13. Accordingly, the cleaning performance can be further stabilized.

The vibrating mechanism of the fourth embodiment can also be applied to the heating-and-cooling sections 14, 17 of the second and third embodiments.

This invention, when practiced illustratively in the manner described above, provides the following major effects:

According to the invention, a high cleaning performance can be maintained and made stable without involvement of an operation for setting the life of liquid. Moreover, the invention enables provision of a cleaning apparatus which affords a high degree of freedom relating to the type of liquid and temperature settings and a wide range of application.

Further, the present invention is not limited to these embodiments, but variations and modifications may be made without departing from the scope of the present invention.

The entire disclosure of Japanese Patent Application No. 2002-209344 filed on Jul. 18, 2002 containing specification, claims, drawings and summary are incorporated herein by reference in its entirety.

What is claimed is:

1. A cleaning apparatus comprising:
a substrate retaining section for retaining a side edge of a substrate;
a first heating-and-cooling section for heating or cooling a surface thereof and arranged such that a predetermined first clearance is provided between the surface of said first heating-and-cooling section and one surface of the substrate; and
a first cleaning liquid filling section for filling the first clearance with first cleaning liquid.

2. The cleaning apparatus according to claim 1, further comprising:
a second heating-and-cooling section for heating or cooling a surface thereof and arranged such that a predetermined second clearance is provided between the surface of said second heating-and-cooling section and another surface of the substrate; and
a second cleaning liquid filling section for filling the second clearance with second cleaning liquid.

3. The cleaning apparatus according to claim 1, further comprising a cleaning liquid supply section for supplying second cleaning liquid to another surface of the substrate.

4. The cleaning apparatus according to claim 1, wherein said substrate retaining section rotates around a center of the substrate and spins the substrate.

5. The cleaning apparatus according to claim 1, wherein said first heating-and-cooling section has a plurality of indentations in the surface thereof.

6. The cleaning apparatus according to claim 2, wherein said second heating-and-cooling section has a plurality of indentations in the surface thereof.

7. The cleaning apparatus according to claim 1, further comprising a mechanism for oscillating the surface of said first heating-and-cooling section.

8. The cleaning apparatus according to claim 2, further comprising a mechanism for vibrating the surface of said second heating-and-cooling section.

9. The cleaning apparatus according to claim 1, wherein said substrate retaining section has a plurality of chuck pins of low heat conductivity, and the substrate does not contact a member having heat capacity.

10. A method of manufacturing a semiconductor device, comprising a step of cleaning a substrate through use of the cleaning apparatus according to claim 1.
